(19) United States
(12) Patent Application Publication
(10) Pub. No.: US 2023/0269713 A1
(43) Pub. Date: Aug. 24, 2023

(54) UE Migration Between Networks In Response To Spectrum Grant Suspension

(71) Applicant: CHARTER COMMUNICATIONS OPERATING, LLC, St. Louis, MO (US)

(72) Inventors: Saran Khalid, Denver, CO (US); MohammedYusuf Shaikh, Denver, CO (US); Perwaiz Akhtar, Aurora, CO (US)

(73) Assignee: CHARTER COMMUNICATIONS OPERATING, LLC, St. Louis, MO (US)

(21) Appl. No.: 17/677,215

(22) Filed: Feb. 22, 2022

(51) Int. Cl. H04W 72/04; H04W 72/10

(52) U.S. Cl. CPC H04W 72/0453; H04W 72/10

(57) ABSTRACT

Various embodiments comprise systems, methods, architectures, mechanisms and apparatus for managing UE migration between a shared spectrum primary and a secondary network by efficiently capturing UE session snapshots so as to prioritize UE migration by active services from the primary to the secondary network in response to loss of spectrum conditions requiring such migration, and to provide a mechanism by which UE are migrated back to the primary network as soon as shared spectrum becomes available.

### FIELD OF THE DISCLOSURE

The present disclosure generally relates to wireless communications systems and related networks, and more particularly to user equipment migration between network services providers.

### BACKGROUND

This section is intended to introduce the reader to various aspects of art, which may be related to various aspects of the present invention that are described and/or claimed below. This discussion is believed to be helpful in providing the reader with background information to facilitate a better understanding of the various aspects of the present invention. Accordingly, it should be understood that these statements are to be read in this light, and not as admissions of prior art.

Mobile network operators (MNOs) typically own and manage significant telecommunications infrastructure used to provide wireless services via cellular coverage for users of their cellular/mobile network services. MNOs have deployed universal mobile telecommunications system (UMTS) nodes and/or high-speed packet access (HSPA) nodes to provide coverage to the users of their network. These deployments have been augmented by the deployment of third generation partnership project (3GPP) long term evolution (LTE) coverage (e.g., 4G/LTE) to increase network performance, provide new services and so on. New and planned deployment of 5G New Radio (5G NR) and related technologies provides further improvements in network performance as well new or improved network services.

Mobile virtual network operators (MVNOs) may own little or none of the telecommunications infrastructure used to provide wireless services for their users. For example, network operators such as cable television Multiple-System Operators (MSOs) may operate as MVNOs via a dual-network deployment model wherein existing (though limited) MSO wireless infrastructure is augmented via telecommunications infrastructure of a partner MNO so as to offer to offer wireless services to MVNO customers.

Increasing demands for wireless throughput make access to additional wireless spectrum desirable, including both licensed and unlicensed spectrum, spectrum in multiple spectral regions, such as high bands (24 GHz-40 GHz for 5G), mid bands (3.5 GHz-6 GHz and/or 1 GHz-2.6 GHz for 4G/LTE/5G), and low bands (<1 GHz for 4G/LTE/5G), and other shared spectrum.

Shared spectrum usage rules typically contemplate 3-tiered shared access; namely, (1) Incumbent operations, (2) Priority Access Licenses (PAL) which are used for commercial operation, and (3) General Authorized Access (GAA) which is available without licenses and subject to FCC Part 96 rules. GAA compliance may at times require a revocation of granted spectrum and/or a reduction in transmit power/range of devices using unlicensed spectrum (e.g., mobile network base stations/eNBs/gNBs and the like), such as when a GAA-define prioritized user requires this spectrum.

Spectrum associated with citizens broadband radio service (CBRS) is currently configured as a 150 MHz band between 3.55 GHz and 3.70 GHz. Spectrum access is granted to Citizens Broadband Radio Service Devices (CBSDs), such as base stations, eNBs, gNBs, user devices and the like via a Spectrum Access System (SAS) operating in accordance with, illustratively, a CBSD-SAS registration and spectrum grant process such as that described in the WINNF-TS-0016 standards document.

PAL is guaranteed channel assignment within the first 100 MHz of CBRS spectrum, with the remaining CBRS spectrum being used for GAA. However, user access is not guaranteed since as incumbent/priority users such as DoD (government), satellite operators, and others take the highest priority. As such, a SAS managing spectrum grants to CBSDs using the CBRS spectrum may suspend such grants in the event of a conflict with a higher priority user, which may require a suspension of PAL/GAA CBSD communications such that the corresponding user equipment (UE) attached to the CBSD and using the suspended PAL/GAA spectrum grants must be detached therefrom and migrated to another MVNO, MNO/partner network, or other alternate infrastructure.

Given that CBSD-detached UEs may be quite numerous, and a large number of UE attempting to gain access to the alternative infrastructure may be disruptive to the infrastructure as well as UE currently attached thereto.

### SUMMARY

Various deficiencies in the prior art are addressed by systems, methods, and apparatus for managing UE migration between a shared spectrum primary and a secondary network by efficiently capturing UE session snapshots so as to prioritize UE migration by active services from the primary to the secondary network in response to loss of spectrum conditions requiring such migration, and to provide a mechanism by which UE are migrated back to the primary network as soon as shared spectrum becomes available.

In various embodiments, a UE migration plan defining priority of UE based on active session(s) criteria may be used to prioritize UE migration between networks. Such migration may be necessitated by, for example, UE being attached to PE nodes via shared spectrum and the PE nodes have received a suspension message indicating a need to stop using shared spectrum or reduce the power/range associated with their use of the shared spectrum (e.g., a migration from MVNO CBSD nodes to non-CBSD MVNO or MNO nodes).

In various embodiments, UE network access via shared spectrum provider equipment (PE) nodes (e.g., CBSD nodes using CBRS spectrum) may be reduced or eliminated due to tiered use requirements such that all UE accessing network services via such shared spectrum PE nodes must be migrated to non-CBSD nodes such as that of a MNO or a different network associated with the MVNO.

Various embodiments contemplate that UE include a connection manager comprising a software agent active at UE and configured to perform various functions associated with capturing/using snapshot information, UE network connection changes, and so on. The connection manager agent (CMA) at the UE may cooperate with a connection manager server (CMS) at a service provider management entity or core network, where the CMS is configured to interact with the CMA at each of a large number of UE so as to perform the various network offloading, migration, load balancing, and other functions which result in changes to connectivity of UE, which functions may be implemented in a prioritized manner such as in accordance with a UE migration plan.

Various embodiments contemplate that geofencing or location data may be used to refine a snapshot capture process so as to avoid having UE expend battery power on capturing snapshot information that will likely not be used. Further, geofencing or location data may be used to assist in the gradual or controlled migration of UE from a preferred network to a backup or secondary network as needed, and the migration of the UE back to the preferred network as the opportunity to do so arises.

The various embodiments advantageously enable and provide for a controlled transition of a large number of UEs in a systematic way with minimal or at least reduced impact on performance.

A method according to an embodiment may comprise: in response to receiving a spectrum grant suspension message associated with spectrum used by a Citizens Broadband Radio Service Device (CBSD) node to provide services to user equipment (UE) attached thereto, transmitting a detachment request and a grant suspension indicative code to each UE associated with the suspended spectrum grant; receiving, from at least a portion of the UE associated with the suspended spectrum grant, respective indications of available nodes of alternate networks and snapshots of active sessions; generating a UE migration plan for the UE associated with the suspended spectrum grant, the UE migration plan comprising a prioritized ordering of UE migration to each node of one or more alternate networks based on UE active session information and alternate network cost, wherein each of the one or more alternate network nodes is associated with a respective UE migration rate; and causing at least the portion of the UE associated with the suspended spectrum grant to initiate a UE migration in accordance with the UE migration plan.

Additional objects, advantages, and novel features of the invention will be set forth in part in the description which follows, and will become apparent to those skilled in the art upon examination of the following or may be learned by practice of the invention. The objects and advantages of the invention may be realized and attained by means of the instrumentalities and combinations particularly pointed out in the appended claims.

### BRIEF DESCRIPTION OF THE DRAWINGS

The accompanying drawings, which are incorporated in and constitute a part of this specification, illustrate embodiments of the present invention and, together with a general description of the invention given above, and the detailed description of the embodiments given below, serve to explain the principles of the present invention.

FIG. 1 depicts a simplified network services architecture suitable for use in various embodiments;

FIG. 2 depicts a flow diagram of a UE migration management method in accordance with the embodiments;

FIG. 3 depicts a flow diagram of a UE handover management method in accordance with the embodiments; and

FIG. 4 graphically depicts a network management method in accordance with the embodiments.

It should be understood that the appended drawings are not necessarily to scale, presenting a somewhat simplified representation of various features illustrative of the basic principles of the invention. The specific design features of the sequence of operations as disclosed herein, including, for example, specific dimensions, orientations, locations, and shapes of various illustrated components, will be determined in part by the particular intended application and use environment. Certain features of the illustrated embodiments have been enlarged or distorted relative to others to facilitate visualization and clear understanding. In particular, thin features may be thickened, for example, for clarity or illustration.

### DETAILED DESCRIPTION

The following description and drawings merely illustrate the principles of the invention. It will thus be appreciated that those skilled in the art will be able to devise various arrangements that, although not explicitly described or shown herein, embody the principles of the invention and are included within its scope. Furthermore, all examples recited herein are principally intended expressly to be only for pedagogical purposes to aid the reader in understanding the principles of the invention and the concepts contributed by the inventor(s) to furthering the art, and are to be construed as being without limitation to such specifically recited examples and conditions. Additionally, the term, “or,” as used herein, refers to a non-exclusive or, unless otherwise indicated (e.g., “or else” or “or in the alternative”). Also, the various embodiments described herein are not necessarily mutually exclusive, as some embodiments can be combined with one or more other embodiments to form new embodiments.

The numerous innovative teachings of the present application will be described with particular reference to the presently preferred exemplary embodiments. However, it should be understood that this class of embodiments provides only a few examples of the many advantageous uses of the innovative teachings herein. In general, statements made in the specification of the present application do not necessarily limit any of the various claimed inventions. Moreover, some statements may apply to some inventive features but not to others. Those skilled in the art and informed by the teachings herein will realize that the invention is also applicable to various other technical areas or embodiments.

Various deficiencies in the prior art are addressed by systems, methods, and apparatus for managing UE migration between MNO and MVNO networks by efficiently capturing UE session snapshots so as to prioritize UE migration between networks in response to conditions requiring such migration. In various embodiments, a UE migration plan defining priority of UE based on active session(s) criteria may be used to prioritize UE migration between networks. Such migration may be necessitated by, for example, UE being attached to PE nodes via shared spectrum and the PE nodes have received a suspension message indicating a need to stop using shared spectrum or reduce the power/range associated with their use of the shared spectrum (e.g., a migration from MVNO CBSD nodes to non-CBSD MVNO or MNO nodes).

In various embodiments, UE network access via shared spectrum provider equipment (PE) nodes (e.g., CBSD nodes using CBRS spectrum) may be reduced or eliminated due to tiered use requirements such that all UE accessing network services via such shared spectrum PE nodes must be migrated to non-CBSD nodes such as that of a MNO or a different network associated with the MVNO.

Various embodiments contemplate that UE include a connection manager comprising a software agent active at UE and configured to perform various functions associated with capturing/using snapshot information, UE network connection changes, and so on. The connection manager agent (CMA) at the UE may cooperate with a connection manager server (CMS) at a service provider management entity or core network, where the CMS is configured to interact with the CMA at each of a large number of UE so as to perform the various network offloading, migration, load balancing, and other functions which result in changes to connectivity of UE, which functions may be implemented in a prioritized manner such as in accordance with a UE migration plan.

Various embodiments contemplate that geofencing or location data may be used to refine a snapshot capture process so as to avoid having UE expend battery power on capturing snapshot information that will likely not be used. Further, geofencing or location data may be used to assist in the gradual or controlled migration of UE from a preferred network to a backup or secondary network as needed, and the migration of the UE back to the preferred network as the opportunity to do so arises.

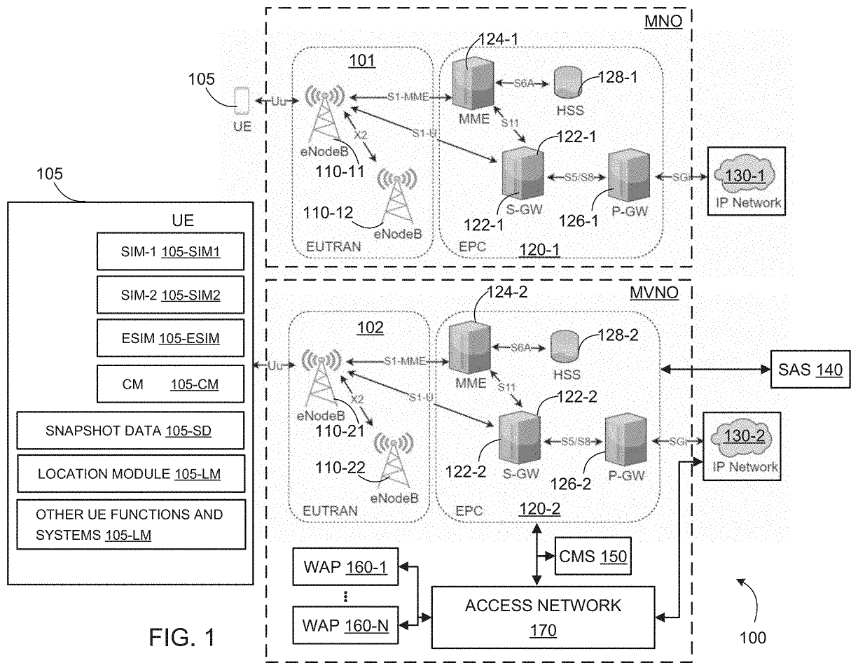

FIG. 1 depicts a simplified network services architecture suitable for use in various embodiments. Specifically, FIG. 1 depicts a first network (e.g., an MNO network) and a second network (e.g., an MVNO network), each network comprising respective deployed networking or telecommunications infrastructure configured to provide network services (e.g., voice, streaming media, data upload/download etc.) services to respective subscribers/users. While various embodiments are depicted and described herein within the context of an MVNO network using infrastructure of an MNO network for service backup purposes the first and second networks do not need to be in an MVNO/MNO arrangement. For example, the second network may comprise unlicensed spectrum infrastructure of an MNO network configured for using licensed spectrum infrastructure (first network) of the same MNO network for service backup purposes.

The MNO network is configured to provide network services to respective subscribers/users via user equipment (UE) 105 configured to communicate with MNO nodes (e.g., nodes 110-11, 110-12, and so on) of, illustratively, a E-UTRAN (LTE access network) connected to a core network, illustratively an evolved packet core (EPC) 120-1, which provides network services from/to external networks 130-1.

As depicted in FIG. 1, the MNO network comprises nodes 110-1x comprising cellular network base stations, eNodeBs (eNBs), 4G/5G repeaters, and similar types of provider equipment or logical radio nodes (e.g., gNBs) derived therefrom. Each node 110-1x provides network services to UE 105 via respective radio bearer (channels/resources) which are managed by various Radio Resource Management functions, such as Radio Bearer Control, Radio Admission Control, Connection Mobility Control, Scheduling of UEs in both uplink and downlink and so on. As depicted, the MNO nodes 110-1x communicate with a core network, illustratively an evolved packet core (EPC) 120-1 comprising a Serving Gateway (SGW) 122-1, a Mobility Management Entity (MME) 124-1, a Packet Data Network (PDN) Gateway (PGW) 126-1, a Home Subscriber Server (HSS) 128-1, and various other network elements (not shown) operative to provide the various functions necessary to enable UE authentication, network services, application services and the like as is known.

In various embodiments, each of the various applications or sessions active at a UE and captured via snapshot is associated with one or more bearer channels of an appropriate QoS level. The active applications/sessions may be prioritized based upon type, bearer channel(s), and/or respective QoS levels or requirements. For example, voice services are more important than multimedia download/presentation services (services are often buffered), which are more important then email or file transfer services.

The MVNO network is configured to provide network services to respective subscribers/users via UE 105 configured to communicate with MVNO nodes (e.g., nodes 110-21, 110-22, and so on) of, illustratively, a E-UTRAN (LTE access network) connected to a core network, illustratively an evolved packet core (EPC) 120-2 and/or a plurality of wireless access points (WAPs) 160-1, 160-2 and so on (collectively WAPs 160) connected to one or more access networks 170, wherein the core network 120-2 and access network(s) 170 provide network services from/to external networks 130-2.

As depicted in FIG. 1, the MVNO network comprises nodes 110-2x comprising macrocells, small cells, microcells and the like such as eNodeBs (eNBs) and similar types of provider equipment or logical radio nodes (e.g., gNBs) derived therefrom. Each node 110-2x provides network services to UE 105 via respective radio bearer (channels/resources) which are managed by various Radio Resource Management functions, such as Radio Bearer Control, Radio Admission Control, Connection Mobility Control, Scheduling of UEs in both uplink and downlink and so on. As depicted, the MVNO nodes 110-2x communicate with a core network comprising, illustratively, an evolved packet core (EPC) 120-2 comprising a Serving Gateway (SGW) 122-2, a Mobility Management Entity (MME) 124-2, a Packet Data Network (PDN) Gateway (PGW) 126-2, a Home Subscriber Server (HSS) 128-2, and various other network elements (not shown) operative to provide the various functions necessary to enable UE authentication, network services, application services and the like as is known.

In some embodiments, the MVNO network comprises a converged network configured to enable UE to access subscriber services via any of a plurality of available wireless networks as long as the QoS requirements are satisfied, such as via available network nodes 110-2x or via any of a plurality of wireless access points (WAPs) 160.

The WAPs 160 of the MVNO network may comprise 802.11xx wireless access points at homes, businesses or other locations configured to communicate with UE 105 and with an access network 170. In various embodiments, the MVNO network services provider utilizes numerous such access points distributed over a “coverage footprint” to provide network services to mobile devices such as the UE 105 discussed herein.

In various embodiments, while attached to a second or backup network (e.g., 4G/LTE/5G nodes 110-1x) the UE connection manager periodically interacts with a first/original network management entity to determine therefrom whether the first/original network (e.g., CBRS nodes 110-2x and/or WAPs 160) has become available again (e.g., the priority use/user triggering the SAS to transmit the initial channel vacate messages is no longer requiring the CBRS spectrum) such that the UE may re-attach itself to the first/original network.

As depicted, the MVNO network includes network nodes 110-2x or WAPs 160 configured to utilize unlicensed spectrum in addition to, or instead of, licensed spectrum. That is, the MVNO network may include network nodes 110-2x or APs 160 configured to utilize unlicensed or shared spectrum in various unlicensed spectral regions, such as high bands (24 GHz-40 GHz for 5G), mid bands (3.5 GHz-6 GHz and/or 1 GHz-2.6 GHz for 4G/LTE/5G), and low bands (<1 GHz for 4G/LTE/5G), and other shared spectrum.

In various embodiments, at least some of the network nodes 110-2x and/or APs 160 of the MVNO network are configured to operate in at least some modes of operation as Citizens Broadband Radio Service Devices (CBSDs) utilizing spectrum associated with the Citizens Broadband Radio Service (CBRS), which is currently configured as a 150 MHz band between 3.55 GHz and 3.70 GHz. Spectrum access is granted to CBSDs, such as base stations, eNBs, gNBs, WAPs, UE the like via a Spectrum Access System (SAS) 140 operating in accordance with, illustratively, a CBSD-SAS discovery, authentication, registration, spectrum inquiry, spectrum grant, heartbeat, grant relinquishment, grant suspension, deregistration, and/or other procedures such as that described in the WINNF-TS-0016 standards document.

It is further noted that different types of deployed MNO and MVNO infrastructure may be used within the context of the various embodiments, such as via differing types of nodes 110 supported by 4G/LTE, 5G New Radio, and/or other types of core networks 120, differing types of WAPs 160, and so on.

As depicted in FIG. 1, the UE 105 may comprise any type of wireless device configured for use in accordance with the various embodiments, such as user terminals (e.g., mobile phones, laptops, tablets and the like), fixed wireless access devices (e.g., set top boxes, digital video recorders, stationary computing devices and the like), Internet of Things (IoT) devices (e.g., sensors, monitoring devices, alarm system devices and the like), and/or other wireless devices. The UE 105 may include UE associated with mobile network protocols (e.g., 3G/4G/LTE/5G), WiFi protocols (e.g., 802.xx), and the like.

The various embodiments contemplate the UE 105 are configured to communicate via each of the first MNO and second MVNO networks. In the case of each of these network utilizing mobile network (MN) radio access technology (RAT) such as 3G, 4G/LTE, and 5G, the UE 105 so configured may comprise dual SIM UE (e.g., two SIM card capability, one SIM card and an eSIM, etc.). As such, and as depicted in FIG. 1, UE 105 comprise a first SIM 105-SIM1 and at least one of a second SIM 105-SIM2 and an eSIM 105-ESIM.

As depicted in FIG. 1, the UE 105 comprise a first subscriber identity module (SIM) 105-SIM1 and at least one of a second SIM 105-SIM2 and an eSIM 105-ESIM, wherein a first SIM (or eSIM) is associated with a first subscription tied to the MNO network, and a second SIM (or eSIM) is associated with a second subscription tied to the MVNO small cell network. The UE 105 may comprise enhanced dual-subscription devices like Dual SIM Dual Standby (DSDS) UE. Further, a location module 105-LM may also be provided in the UE 105. Various other UE functions are also provided within the UE, though such functions are not discussed in detail herein.

Further, the UE 105 comprise a connection manager 105-CM configured to perform various functions such as will be described below, including gathering snapshot data (which may be stored in a snapshot database 105-SD), obtaining data relating to a quality of service or strength of signal of each of (i) a MVNO/MSO-provided CBRS service, and (ii) a MNO-provided cellular service to assist in the selection of one over the other based on the comparison (e.g., selection of a MVNO node 110-2x or MNO node 110-1x proximate the UE 105), communicating with various management entities such as a connection manager server at a home network (e.g., the MVNO network) so as to manage the timing and selection of service node attachment.

Generally speaking, the CM 105-CM and CMS 150 operate to assist/control a UE 105 in selecting an appropriate network (e.g., the MNO network when the MVNO network is not available, or the MVNO network when it becomes available) to transmit and receive user/application data. It will be noted that while an enhanced DSDS UE 105 with CM 105-CM enables internet data traffic to be transferred through either of the MNO and MVNO networks, the end-user of the DSDS UE 105 (i.e., the user of UE 105) may only see connectivity to one network advertised in the device display, such as the MNO network. In other words there may be no indication regarding MVNO small cell network to the end-user, and the end-user may not necessarily be made aware whether MVNO small cell network being utilized at any given time.

The UE connection manager 105-CM may comprise a computer program operative to execute on a digital processor apparatus, and configured to, when executed, obtain data relating to a quality of service or strength of signal of each of (i) the MSO-provided CBRS service, and (ii) the MNO-provided cellular service, and cause selection of one over the other based on the comparison. In one implementation, the connection manager entity (e.g., program) is disposed on a user mobile device (e.g., UE), and configured to autonomously obtain QoS data and perform a comparison of the networks based upon the obtained QoS data, such as at the then current location of the UE. In other embodiments, the UE connection manager 105-CM cooperates with the CMS 150 to provide thereto QoS data and/or other network or UE performance measurements such that the CMS 150 may perform network comparisons and other analysis (e.g., evaluate the CBRS and MNO cellular options at one or more locations within a prescribed CBRS coverage area for one or more nodes 110-1x/110-2x).

Various embodiments contemplate that PE managing MVNO network nodes 110-2x/160-x are also monitoring the use of unlicensed spectrum by these nodes, such as via interacting with the nodes 110-2x/160-x and/or the SAS 140 operative to control the use of such spectrum. In this manner, the PE may be configured to respond at a network-level to UE migrations resulting from localized suspension of spectrum grants by the SAS. In various embodiments, the CMS 150 or other PE management entities communicate with the SAS 140 via standard messaging techniques to remain aware of spectrum grant status so as to response to changes in such status in accordance with, illustratively, a UE migration plan.

Various elements or portions thereof depicted in FIG. 1 and having functions described herein are implemented at least in part as computing devices having communications capabilities, including for example the UE 105, nodes 110, SAS 140, CMS 150, WAPs 160 and various portions of the core networks 120. These elements or portions thereof have computing devices of various types, though generally a processor element (e.g., a central processing unit (CPU) or other suitable processor(s)), a memory (e.g., random access memory (RAM), read only memory (ROM), and the like), various communications interfaces (e.g., more interfaces enabling communications via different networks/RATs), input/output interfaces (e.g., GUI delivery mechanism, user input reception mechanism, web portal interacting with remote workstations and so on) and the like.

As such, the various functions depicted and described herein may be implemented at the elements or portions thereof as hardware or a combination of software and hardware, such as by using a general purpose computer, one or more application specific integrated circuits (ASIC), or any other hardware equivalents or combinations thereof. In various embodiments, computer instructions associated with a function of an element or portion thereof are loaded into a respective memory and executed by a respective processor to implement the respective functions as discussed herein. Thus various functions, elements and/or modules described herein, or portions thereof, may be implemented as a computer program product wherein computer instructions, when processed by a computing device, adapt the operation of the computing device such that the methods or techniques described herein are invoked or otherwise provided. Instructions for invoking the inventive methods may be stored in tangible and non-transitory computer readable medium such as fixed or removable media or memory, or stored within a memory within a computing device operating according to the instructions.

For purposes of this discussion, it is assumed that the owners of the first network (e.g., an MNO) and the owners of the second network (e.g., an MVNO) have in place an agreement whereby UE 105 associated with subscribers/users of the MVNO network are able to receive subscribed-for services via the MNO network in areas where the infrastructure associated with the MVNO network (e.g., nodes 110-2x) do not provide sufficient network coverage or services to the UE 105, wherein such coverage/services is instead provided to the UE 105 via infrastructure associated with the MNO network (e.g., nodes 110-1x). In this case, the UE 105 attached to a MVNO node 110-2x is handed over to a MNO node 110-1x.

Various embodiments facilitate the mitigation of UE receiving MVNO services via unlicensed spectrum when attached to a CBSD node (e.g., 110-2x or WAP 160) in the case of a suspension of a spectrum grant to the CBSD node.

In particular, the connection manager (CM) of the UE 105 is configured to maintain snapshots of active sessions (or acquire snapshot upon receiving a suspension notice), to query the CBSD for a grant suspension code, and to provide this information to provider equipment (PE) such as network managers (NMs) and the like to enable managed attachment/reattachment of the UE population impacted by the suspension notice.

The network manager (NM) is configured to prioritize reattachment of suspended UE in a load balanced manner. This determination is made in accordance with various criteria associated with suspended UE, such as (1) whether UE was UE idle; (2) whether UE was associated with multiple active sessions or one active session; (3) whether UE was associated with high bandwidth/demand session(s) vs low bandwidth/demand session(s); (4) whether UE is capable of multiple network access (e.g., dual RAT, dual SIM, eSIM); (5) UE location with respect to alternative infrastructure (e.g., attachable to one, few, or many alternative infrastructures or infrastructure access points); (6) UE subscription/priority level (e.g., platinum, gold, silver, bronze); and (7) any other criteria useful in this determination.

The NM migrates UE (i.e., detaches from old node/WAP and attaches to new node/WAP) in a prioritized manner in accordance with the UE/subscriber criteria, and further in consideration of factors such as the cost to the MVNO. Such costs include the cost of using alternate infrastructure such as MNO infrastructure where the MVNO must pay a fee to the MNO (e.g., per-bit fee, per-tier fee, etc.) These costs may vary depending upon the required performance of the US application(s) services(s), the loading of the alternate infrastructure, and so on. Preference is always given to infrastructure owned by the MVNO, with consideration given to the loading and performance match between that infrastructure and UE/services QoS requirements. It is noted that the migration of UE from a source network may be to one or more destination networks.

The rate of UE migration may also be considered determined by the NM so as to avoid overloading alternative infrastructure(s), avoid unmanageable spikes in control plane functions/signaling, and so on.

Finally, the CM of the UE is configured to restore migrated UE from costly alternate infrastructure back to the normal MVNO infrastructure based on based on speed of the UE, session priority and the like, and to do so in a manner reducing signaling collisions and the like.

CBRS incumbents (US Military, fixed satellite etc.) have the highest priority over the entire CBRS frequency range. If a network operator is operating in this band, there is a possibility that SAS can order the network operator's network devices to vacate the CBRS channels (PAL and GAA) which will result in disruption of service to the subscribers on the network. In order to avoid a disruption (with no defined time span of the shut down call) the users must be provided an alternative way of communications to avoid poor experience. The subscribers must be provided an alternative. This can be handled by placing the subscribers from the native CBRS network onto a partner/MVNO network (non-native). This placement can be seriously disruptive to the non-native network as it may not be able to handle a large number of additional UEs all of a sudden.

This various embodiments disclosure provides a mechanism to ensure there is a priority based transfer of UEs to the non-native networks. In addition, the disclosure also discusses mechanism to move the UEs back on the native network in a systematic way post shutdown call from SAS.

Generally speaking, various embodiments provide a method/mechanism for transfer/migration of UE attached to MVNO CBSD nodes/APs with suspended spectrum grants to nodes/APs of alternate infrastructure or non-native networks, such as that of an MNO. In addition, various embodiments provide a method/mechanism for transfer/migration of UE back to MVNO nodes/APs, such as after a shutdown call from an SAS.

In response to spectrum grant suspension messages, the CMS 150 or other network management entity may identify impacted nodes 110-2x/160-x and UE 105 connected thereto, invoke snapshot gathering and reporting, apply UE active session prioritization to the reported snapshot information, and begin migrating UE in accordance with a migration plan to secondary network nodes.

The CMS 150 or other network management entity may also continue to interact with the SAS 150 so as to become aware of the return of non-licensed spectrum availability (e.g., priority user no longer in area associated with spectrum grans suspensions) so as to begin migrating UE back to a preferred network. Such return migration may comprise provoking the nodes 110-2x/160-x to again transmit spectrum inquiry messages to the SAS 140, receive spectrum grants, and begin using the granted spectrum, whereupon the CMS 150 or other network management entity may then cause a migration of UE back to the CBSD network (more generally, to the preferred network).

In the event a SAS grant has been suspended the network will be forced to go an alternative channel i.e., PAL on a different GAA and a GAA on a different GAA. In the worst case the network will have no grants (neither PAL nor GAA) and will cease operations.

In the event that there is no grant, the mobile subscribers will not know what happened and will either be disassociated or look for an alternatives. This will be carried over the allowed frequency range of the carrier. The mobiles will continue to transmit in order to find the frequency causing a power surge which is detrimental anyway.

In order to resolve this an agent on the phone (connection manager) can take on this situation but requires additional functionality. Normally, when a SAS suspends grants it lets the network know via suspend grant message. This suspension stays with the network and is not relayed to the UE. A connection manager can request the reason for suspension so it can direct the UE in the right direction.

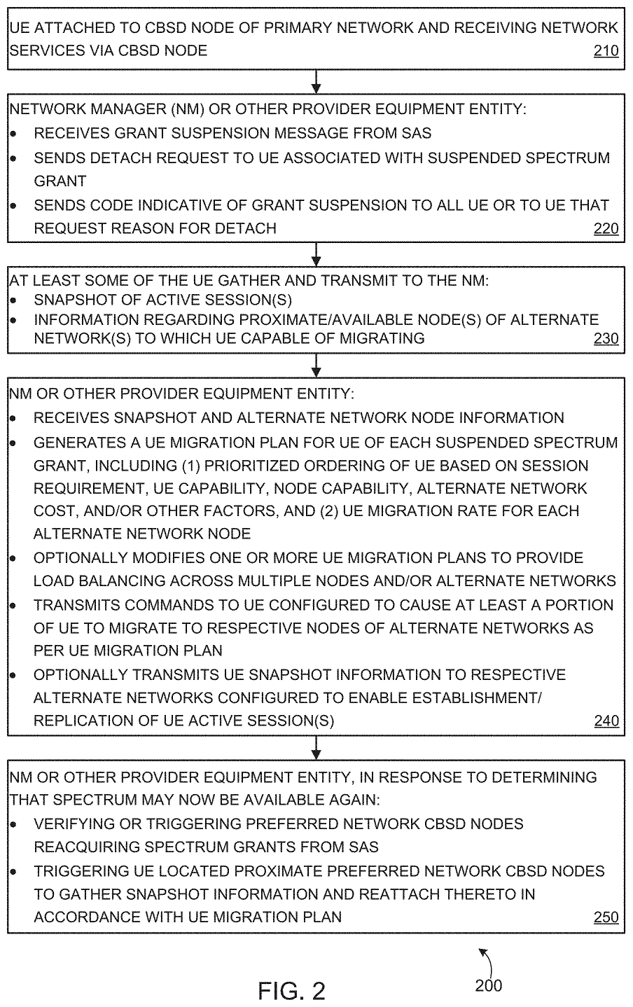

FIG. 2 depicts a flow diagram of a UE migration management method in accordance with the embodiments.

At step 210, UE are attached to a CBSD node of primary network (e.g., MVNO network) and receiving network services via the CBSD node.

At step 220, a network manager (NM) or other provider equipment (PE) entity such as associated with the MVNO operator receives a grant suspension message from an SAS associated with spectrum granted to one or more CBSDs. The NM responsively sends detach request to UE associated with each suspended spectrum grant (i.e., UE using suspended spectrum grants at any of the relevant CBSDs). The NM also sends codes indicative of grant suspension to all UE, or to UE that have sent a “request reason for detach” message to the NM.

At step 230, at least some of the UE gather and transmit to the NM respective snapshot information pertaining to active UE sessions, as well as information regarding proximate/available node(s) of alternate network(s) to which UE capable of migrating.

Specifically, in various embodiments, the CM of the UE is configured to facilitate UE session migration by maintaining an active profile of active applications, such as via snapshots configured to keep track of active packet flows for each application by, illustratively, tracking such application packet flows at the packet level and maintaining a corresponding snapshot of current application packet flows.

A snapshot for the UE may comprise control information as well as information pertaining to each application of interest (i.e., each application where rapid handover without application disruption is desired). A snapshot may include some or all of the following information for each application of interest: Server information such as IP Address; UE Credentials such as User IDs (e.g., IMSI, IMEI, C-RNTI, etc.); Session ID such as PDN ID, EPS bearer ID, LBI and TEID etc.; and Packet flow information such as packet number, packet sequence, and the like. A snapshot may also include some or all of the following control information: Server information such as IP Address; UE Credentials such as User IDs (e.g., IMSI, IMEI, C-RNTI, etc.); Session ID such as PDN ID, EPS bearer ID, LBI and TEID etc.; and Packet flow information such as packet number, packet sequence and the like.

At step 240, the NM (or other PE entity) receives respective snapshot information and alternate network node information from UE associated with one or more CBSD subjected to a spectrum grant suspension. The NM generates a UE migration plan for UE of each suspended spectrum grant, including (1) prioritized ordering of UE based on session requirement, UE capability, node capability, alternate network cost, and/or other factors, and (2) UE migration rate for each alternate network node.

The UE migration plan includes a prioritized ordering of UE migration to each node of one or more alternate networks based on UE active session information and alternate network cost, wherein each of the one or more alternate network nodes is associated with a respective UE migration rate. The lowest priority is given to UE in an idle state. These UE are just migrated without regard for active session information, since there is none (or the UE failed to provide such information). UE having multiple active sessions are typically prioritized over or higher than UE having fewer active sessions or one active session. UE having relatively higher bandwidth active sessions (e.g., video) are typically prioritized over or higher than UE having relatively lower bandwidth active sessions (e.g., audio only, email, etc.). UE having a relatively higher bandwidth requirement aggregated over many active sessions are typically prioritized over or higher than UE having a relatively lower bandwidth requirement aggregated over many active sessions. UE that can only connect to one alternate network node are typically prioritized over or higher than UE able to connect to several alternate network nodes (this may be due to UE capability to only connect to certain networks such as via certain protocols, or UE location where only one or a few alternate network nodes are providing services). UE with more expensive/higher subscription levels are typically prioritized over or other UE with less expensive/lower subscription levels.

Optionally, the NM modifies one or more UE migration plans to provide load balancing across multiple nodes and/or alternate networks. For example, one or more UE migration plans may be configured to balance UE migration between nodes of a target alternative network and one or more other alternate networks in accordance with at least one of real time target network loading information, historical target network loading information, and other alternate network loading information.

At step 240, the NM transmits commands to UE configured to cause at least a portion of UE to migrate to respective nodes of alternate networks as per UE migration plan. Optionally, the NM transmits UE snapshot information to respective alternate networks if they are configured to enable establishment/replication of UE active session(s) using the snapshot information.

At step 250, in response to the NM or other PE entity determining that spectrum (e.g., CBRS or other unlicensed spectrum) may now be available again, a process of migrating UE back to the preferred network is invoked.

The determination may comprise receiving a message or other indication from the SAS 140 or from another entity interacting with the SAS 140, or by monitoring messages or other traffic associated with the SAS 140 such as to/from a node 110/160 or CMS 150, or from some other entity (even UE 105 if capable of such monitoring or interaction). For example, a registered CBSD node 110/160 may periodically transmit a spectrum inquiry message to the SAS to identify available spectrum and, in response to spectrum now being available, may further transmit a message to the CMS 150 that spectrum is now available. Alternatively, the CMS 150 may simply monitor or inspect SAS related traffic to identify messages indicative of available spectrum. The NM causes a return migration of UE by verifying (or triggering if needed) CBSD nodes of the preferred network reacquiring spectrum grants from a relevant SAS, and triggering those UE proximate the preferred CBSD nodes to gather snapshot information (if needed) and reattach to the CBSD nodes of the preferred network, optionally in accordance with the UE migration plan.

For example, within the context of CBRS systems, a Spectrum Inquiry procedure may be initiated if the CBSD wants the SAS to indicate specific information on channels available for the CBSD. If there is no Domain Proxy, the CBSD initiates the Spectrum Inquiry procedure by sending a SpectrumInquiryRequest object (cbsdId, inquiredSpectrum, measReport) to the SAS. The cbsdId parameter identifies the CBSD to the SAS. The inquiredSpectrum parameter is an array of FrequencyRange objects indicating the frequency range(s) for which the CBSD seeks information. The CBSD may request information for one or more frequency ranges. The measReport parameter provides a means for the CBSD to report measurement results. The SAS returns a SpectrumInquiryResponse object (cbsdId, availableChannel, response) to the CBSD with the results of the potential channel availability for the inquired spectrum. The availableChannel parameter is an array of AvailableChannel objects, each of which includes a frequency range, the channelType (“PAL” or “GAA”) and the regulatory rule that the SAS used to determine availability. The CBSD normally considers the information in the availableChannel parameter as an indication of the channels available to the CBSD. The messaging between a CBSD and the SAS may be monitored by the CMS 150 and used to determine that spectrum is available again. In addition, a CBSD may directly message the CMS 150 to inform the CMS 150 that spectrum is available again. The CMS 150 may further determine the extend of available spectrum, and use this information and snapshot information/priorities to construct a return migration plan for the relevant UE.

Generally speaking, since the UE 105 will not be aware of a return of CBRS spectrum availability they will remain attached to the secondary network. As such, the various embodiments contemplate make such determination at a network management level and causing the UE proximate CBSD nodes of the preferred network to reattach to such preferred network nodes. This and related actions may be provided by the CMS 150 (or other NM entity) communicating with the CM 105CM of the UE 105 to provide instructions thereto.

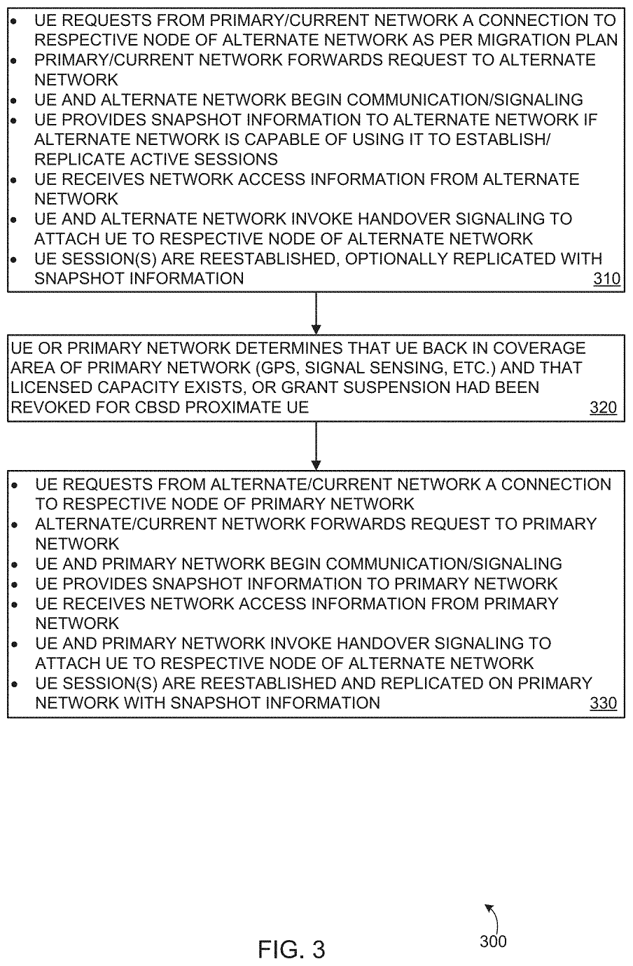

FIG. 3 depicts a flow diagram of a UE handover management method in accordance with the embodiments. Specifically, FIG. 3 depicts a method 300 by which UE are handed over from primary to secondary networks in response to a spectrum suspension condition of primary network CBSD supporting the UE in the primary network, and from secondary to primary networks in response to a revocation of a spectrum suspension condition of a primary network CBSD proximate the UE.

At step 310, in response to a UE receiving from a network manager (NM) or other PE entity of the primary network a message configured to cause UE to migrate to respective nodes of alternate networks as per UE migration plan (e.g., as per step 240 of the method 200 of FIG. 2), the UE requests from the primary/current network a connection to a respective node of an alternate network as per the UE migration plan. The primary/current network forwards these UE request to alternate network. The UE and alternate network begin communication/signaling, and the UE provides active session snapshot information to the alternate network if the alternate network is capable of using it to establish/replicate active sessions. When the UE receives network access information from alternate network, the UE and alternate network invoke handover signaling to attach the UE to a respective node of alternate network, whereupon the UE session(s) are at least reestablished, and preferably replicated with snapshot information.

At step 320, the UE or primary network determines that the UE is in a primary network coverage area (e.g., via GPS at the US, via the primary network nodes sensing signal from the UE, etc.), and that licensed capacity exists at a primary network node proximate the UE, or that a grant suspension associated with a primary network CBSD node proximate the UE has been revoked. In either case, the UE may be migrated back to the primary network such as an MVNO network, and thereby avoid the cost of using the secondary network such as an MNO network.

At step 330, the UE requests from the alternate/current network a connection to a respective node of the primary network as per the UE migration plan. The alternate/current network forwards these UE request to the primary network. The UE and primary network begin communication/signaling, and the UE provides active session snapshot information to the primary network since the primary network is capable of using it to establish/replicate active sessions. When the UE receives network access information from primary network, the UE and primary network invoke handover signaling to attach the UE to a respective node of the primary network, whereupon the UE session(s) are reestablished and replicated using the snapshot information.

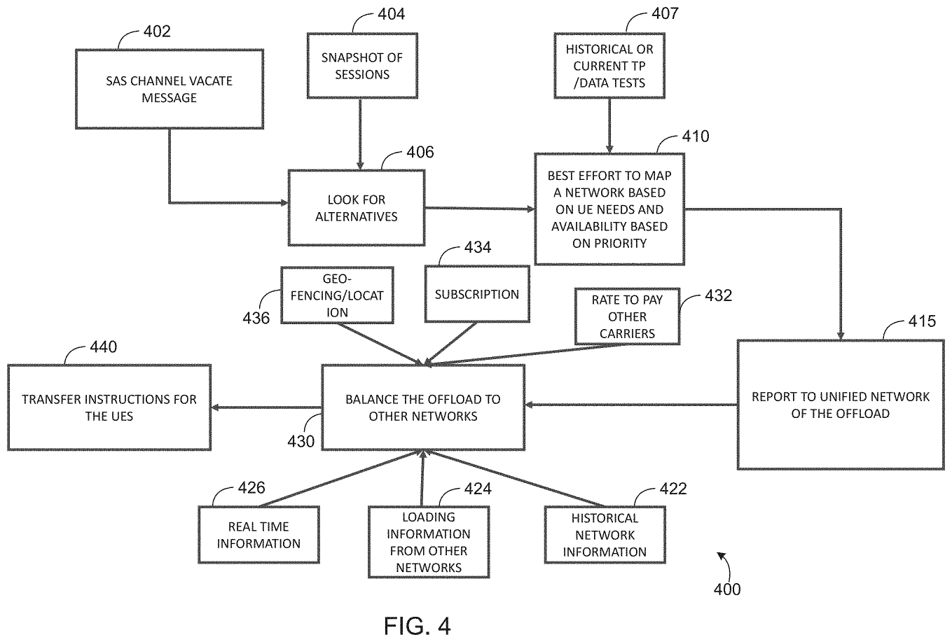

FIG. 4 graphically depicts a network management method in accordance with the embodiments. Specifically, FIG. 4 depicts a simplified flow diagram of messaging and messaging processing associated with various embodiments suitable for use migrating UE from a source network to one or more destination networks in response to the UE having received channel vacate messages.

In response to being informed (402) via a SAS channel vacate message, the UE stop transmitting in the channel(s) to be vacated. The UE will then look for alternatives channels (406) and take a snapshot of existing sessions (404). Based on historical and/or current throughput information, latency information and the like (407) associated with one or more backup networks, a determination will be made as to which of the one or more backup networks will be tasked with receiving various UE under a best effort scenario whereby UE are mapped to a network based on UE needs and availability n accordance with a priority scheme (410). Backup networks may comprise MNS partner networks or other MVNO networks (e.g., MVNO C-band 600 MHz or Wi-Fi network).

Migrating a large number of UEs from a MVNO CBRS spectrum network to an MVNO non-CBRS spectrum network is likely to be capacity constrained if maintaining performance levels of the non-CBRS network. As such, emergency, backup, or fail-over network capacity must be provided by the MVNO or a MNO supporting the MVNO. These networks will be emergency alternatives and be accessed via SIMS or eSIMs on the UE. Further, the UE connection manager will provide a means to transfer the UE between networks. The decision to move UEs to a different network is not only performance based but also based on the cost factor. The UEs will be moved to the cheapest network first i.e., lowest GB/$ (432) and so on.

UE transfer may also be assisted by geo-fencing and location (436) wherein the UEs are moved to other networks based on their locations and the proximate partner networks (i.e., move UE based on location and available network's performance in the area of the UE). The UEs may also be caused to move between networks based on network loading (424) information from the various available networks. In addition, once the UEs are on partner or non-preferred networks they will remain attached thereto indefinitely if they do not look for the primary network. If the UE constantly looks for the primary network it will waste battery life. In various embodiments, battery life of UE on partner networks is conserved by using geo-fencing. However, if the network is unavailable at that time geo-fencing would result in the UE transmitting. In order to avoid the same information that was received to detach would come in handy. The UE will wait for information via non-preferred networks to get informed about when it should enable look up for the primary network. The connection manager will fetch information at pre-defined intervals. The UEs will not be put back on the network all at once. The UEs will be bucketized by the primary network based on the snapshot information provided by the UEs. Hence prioritizing based on subscription, session etc. similar to the description on slide.

Various modifications may be made to the systems, methods, apparatus, mechanisms, techniques and portions thereof described herein with respect to the various figures, such modifications being contemplated as being within the scope of the invention. For example, while a specific order of steps or arrangement of functional elements is presented in the various embodiments described herein, various other orders/arrangements of steps or functional elements may be utilized within the context of the various embodiments. Further, while modifications to embodiments may be discussed individually, various embodiments may use multiple modifications contemporaneously or in sequence, compound modifications and the like. It will be appreciated that the term “or” as used herein refers to a non-exclusive “or,” unless otherwise indicated (e.g., use of “or else” or “or in the alternative”).

Although various embodiments which incorporate the teachings of the present invention have been shown and described in detail herein, those skilled in the art can readily devise many other varied embodiments that still incorporate these teachings. Thus, while the foregoing is directed to various embodiments of the present invention, other and further embodiments of the invention may be devised without departing from the basic scope thereof.

What is claimed is:

1. A method, comprising:
in response to receiving a spectrum grant suspension message associated with spectrum used by a Citizens Broadband Radio Service Device (CBSD) node to provide services to user equipment (UE) attached thereto, transmitting a detachment request and a grant suspension indicative code to each UE associated with the suspended spectrum grant;
receiving, from at least a portion of the UE associated with the suspended spectrum grant, respective indications of available nodes of alternate networks and snapshots of active sessions;
generating a UE migration plan for the UE associated with the suspended spectrum grant, the UE migration plan comprising a prioritized ordering of UE migration to each node of one or more alternate networks based on UE active session information and alternate network cost, wherein each of the one or more alternate network nodes is associated with a respective UE migration rate; and
causing at least the portion of the UE associated with the suspended spectrum grant to initiate a UE migration in accordance with the UE migration plan.

2. The method of claim 1, wherein the UE migration plan assigns a lowest priority to UE in an idle state.

3. The method of claim 1, wherein the UE migration plan prioritizes UE having multiple active sessions over UE having one active session.

4. The method of claim 1, wherein the UE migration plan prioritizes UE in accordance with a number of active sessions.

5. The method of claim 1, wherein the UE migration plan prioritizes UE having an active high bandwidth session over UE having an active low bandwidth session.

6. The method of claim 1, wherein the UE migration plan prioritizes UE in accordance with a total bandwidth usage of active sessions.

7. The method of claim 1, wherein the UE migration plan prioritizes an alternate network node for use by UE capable of only connecting the alternate network node over UE capable of connecting to the alternate network node and one or more other alternate network nodes.

8. The method of claim 7, wherein capability of UE to connect to an alternate network node is based on at least one of UE location proximate the alternate network node, and UE capability to use a radio protocol associated with the alternate network node.

9. The method of claim 1, wherein the UE migration plan prioritizes an alternate network node for use by UE capable of only connecting the alternate network node over UE capable of connecting to the alternate network node and one or more other alternate network nodes.

10. The method of claim 1, wherein the UE migration plan prioritizes UE in accordance with US subscription level.

11. The method of claim 1, wherein the UE migration plan is configured to balance UE migration between nodes of a target alternative network and one or more other alternate networks in accordance with at least one of real time target network loading information, historical target network loading information, and other alternate network loading information.

12. The method of claim 1, further comprising:
in response to determining that spectrum associated with a suspended grant may be available, triggering UE proximate CBSD nodes to attach thereto.

13. The method of claim 12, wherein the determination that spectrum associated with a suspended grant may be available comprises identifying SAS messages associated with successful spectrum availability inquiry.

14. The method of claim 1, wherein the UE are triggered to attach to proximate CBSD nodes in accordance with a UE migration plan.

15. The method of claim 12, wherein the determination that spectrum associated with a suspended grant may be available is made in response to detecting SAS message traffic indicative of a successful spectrum inquiry request.

16. The method of claim 12, wherein the determination that spectrum associated with a suspended grant may be available is made in response to a message from a CBSD node indicative of a successful spectrum inquiry request.

17. A computer implemented connection manager server (CMS) for managing user equipment (UE) connection to nodes of preferred and secondary networks, the CMS comprising compute and memory resources configured for:
in response to receiving a spectrum grant suspension message associated with spectrum used by a Citizens Broadband Radio Service Device (CBSD) node to provide services to user equipment (UE) attached thereto, transmitting a detachment request and a grant suspension indicative code to each UE associated with the suspended spectrum grant;
receiving, from at least a portion of the UE associated with the suspended spectrum grant, respective indications of available nodes of alternate networks and snapshots of active sessions;
generating a UE migration plan for the UE associated with the suspended spectrum grant, the UE migration plan comprising a prioritized ordering of UE migration to each node of one or more alternate networks based on UE active session information and alternate network cost, wherein each of the one or more alternate network nodes is associated with a respective UE migration rate; and
causing at least the portion of the UE associated with the suspended spectrum grant to initiate a UE migration in accordance with the UE migration plan.

18. The CMS of claim 17, wherein the UE migration plan assigns a lowest priority to UE in an idle state, prioritizes UE having multiple active sessions over UE having one active session, and prioritizes UE having an active high bandwidth session over UE having an active low bandwidth session.

19. The CMS of claim 17, wherein the UE migration plan prioritizes an alternate network node for use by UE capable of only connecting the alternate network node over UE capable of connecting to the alternate network node and one or more other alternate network nodes, wherein capability of UE to connect to an alternate network node is based on at least one of UE location proximate the alternate network node, and UE capability to use a radio protocol associated with the alternate network node.

20. User equipment (UE) configured to communicate with provider equipment (PE) of each of a first and second network and comprising compute and memory resources configured for implementing a connection manager (CM), the CM configured to perform a method, comprising:
at UE attached to a Citizens Broadband Radio Service Device (CBSD) node of a first network, in response to receiving a detachment request and a code indicative of a grant suspension, transmitting toward a network manager (NM) associated with the first network an indication of second network nodes proximate the UE and snapshots of any active UE sessions, the transmitted information being configured to enable the NM to generate a migration plan for each of a plurality of UE associated with the grant suspension; and
in response to a migration trigger indication received from the NM, detaching from the CBSD node of the first network and initiating attachment to a node of the second network.

21. The UE of claim 20 further comprising:
in response to the detachment request, transmitting toward the NM a request for a reason for the detachment configured to cause the NM to transmit toward the UE the code indicative of a grant suspension.
